(19) United States
(12) Patent Application Publication
(10) Pub. No.: US 2025/0314299 A1
(43) Pub. Date: Oct. 9, 2025

(54) BI-DIRECTIONAL COMPRESSION LOADED MECHANICAL PACKING SEALING ASSEMBLY

(71) Applicant: A.W. CHESTERTON COMPANY, Groveland, MA (US)

(72) Inventors: Henri Vincent AZIBERT, Windham, NH (US); Joseph K. KALESHIAN, Burlington, MA (US)

(21) Appl. No.: 19/193,493

(22) Filed: Apr. 29, 2025

Related U.S. Application Data
(63) Continuation-in-part of application No. 19/173,426, filed on Apr. 8, 2025.
(60) Provisional application No. 63/631,891, filed on Apr. 9, 2024.

(51) Int. Cl. F16J 15/18; F16J 15/22

(52) U.S. Cl. CPC F16J 15/184; F16J 15/22

(57) ABSTRACT

A mechanical packing sealing assembly having an axially movable pressure adjustment element for applying a pressure to a packing assembly, a packing pressure adjustment element for selectively axially moving the pressure adjustment element, and position locking element for defining an axially outboard most position of the pressure adjustment element. The mechanical packing sealing assembly can also include a plurality of packing elements forming a packing assembly that are sized and configured for seating within a recess of stationary equipment and about the pressure adjustment element.

### RELATED APPLICATIONS

The present application is a continuation-in-part patent application of U.S. patent application Ser. No. 19/173,426, filed on Apr. 8, 2025, entitled Pressure Balanced Self-Regulating Mechanical Packing Sealing Assembly, which claims priority to U.S. provisional patent application Ser. No. 63/631,891, filed on Apr. 9, 2024, and entitled Pressure Balanced Self-Regulating Mechanical Packing Sealing Assembly, the contents of which are herein incorporated by reference.

### BACKGROUND OF THE INVENTION

The present invention relates to a mechanical packing sealing arrangement suitable for use with a fluid regulating device.

There exists in the art many different types of fluid regulating devices, including for example valves, regulators, pumps, differential pressure transducers and the like. Conventional fluid regulating devices, such as valves and pumps, are used in many different types of commercial applications to help regulate the flow of a fluid through a fluid conveyance system. Conventional valves, for example, come in many different shapes and sizes, and can include for example block or gate valves, control valves and the like. When used in commercial applications, the valves or pumps typically employ a mechanical packing assembly mounted in stationary equipment that helps reduce fluid loss and the amount of unwanted gaseous emissions that leak or are accidentally emitted from the valve or pump about the moving shaft.

The packing material typically includes a plurality of separate packing elements or components that are axially stacked together in a groove formed in the stationary equipment housing (e.g., stuffing box) of the fluid regulating device. The packing assembly is mounted about and contacts a movable shaft so as to form a fluid seal therewith. The length of each of the packing elements is typically calculated and then cut from a roll of packing material that comes in rope form, and the number of packing elements that are needed to be mounted within the equipment also needs to be determined. The individually cut packing elements are then mounted and stacked within the equipment one at a time, with careful attention being paid to the orientation of the end of each ring of packing material. An axially movable gland follower or compression gland can be employed to selectively compress the packing assembly. As the packing assembly is compressed, the packing elements expand radially to create a suitable fluid seal between the shaft and the stationary equipment housing. The seal formed by the packing assembly minimizes fluid leakage and helps maintain a pressure boundary between the process fluid housed within the stationary equipment and the external atmosphere.

An example of a conventional fluid regulating device that mounts a conventional packing assembly is shown for example in FIGS. 9-11. The illustrated fluid regulating device 200 can include a stationary equipment housing 202 that has a groove 204 formed along an inner surface that is sized and configured for mounting a packing assembly 210. The groove formed along the inner surface forms the stuffing box of the stationary equipment housing 202. The stationary equipment housing 202 can be mounted about a movable shaft 206. The packing assembly 210 can include a series of packing elements 212 that are mounted and stacked within the groove 204, as is known in the art. According to one conventional embodiment, the groove 204 can be typically sized to accommodate anywhere between three and seven packing elements 212, depending upon the type and size of the fluid regulating device. In the example embodiment, five packing elements 212 are mounted within the groove 204. The device 200 can also include a compression gland element or adjustment mechanism 220 that is coupled to the stuffing box 202 by a series of fasteners 224. The gland element 220 can apply a compression or compressive force to the packing assembly 210 by compressing the packing elements both axially and radially so as to ensure scaling contact between the packing assembly 210 and the shaft 206. The forces applied by the gland element 220 can be manually adjusted.

A drawback of the conventional mounting techniques for the packing elements in conventional fluid regulating devices is that the compression gland element 220 applies a unidirectional force to the packing assembly 210, and the compression forces generated by the gland element 220 are unevenly distributed among and across the axially stacked packing elements 212. Further, the process fluid within the stationary equipment also applies a compressive force to the packing assembly 210 in a direction opposite to the compression gland 220. The force applied by the process fluid is also unevenly distributed among and across the packing elements 212. Specifically, the axially outboard most packing element 212A that contacts the compression gland element 220 is exposed to higher compressive forces from the gland element than the axially innermost or inboard packing element 212B, which is located opposite to the packing element 212A. Similarly, the axially inboard most packing element 212B experiences higher compression forces from the process fluid than the outboard packing element 212A since the packing element 212B is disposed adjacent to the process fluid. Thus, the top or outboard packing element 212A is subjected to the highest compression gland load with minimal exposure to the process fluid pressure, while the bottom inboard packing element 212B is subjected to the least amount of gland load with the highest exposure to the process fluid pressure. As shown in FIG. 11, the illustrated graph 230 shows the axial distribution of compressive forces across the packing assembly 210 as a function of the compression forces applied by the compression gland and by the process fluid. For example, the illustrated line graph 230 illustrates along the X-axis 232 the packing elements 212 in the packing assembly 210, denoted as rings 1-4, where ring 1 is referred to as the outer ring (axial outboard ring) 212A and ring 4 is referred to as the inner ring (axial inboard ring) 212B. The graph 230 also includes a Y-axis 234 indicative of or representing the percentage of the applied compressive load, either from the compression gland or from the process fluid. The line graph 230 includes a legend 236 indicating information associated with the lines 238, 240 of the line graph 230. As shown, the line 238 indicates the force information associated with the compressive forces applied to the packing elements by the compression gland 220. The forces applied to the packing elements decreases across the axially stacked packing elements from the outboard side to the inboard side, with ring 1 experiencing the highest compressive load and ring 4 experiencing the lowest compressive load. Further, line 240 indicates the force information associated with the compressive forces applied to the packing elements 212 by the process fluid. The forces applied to the packing elements 212 decreases across the axially stacked packing elements from the inboard side to the outboard side, with ring 4 experiencing the highest compressive load and ring 1 experiencing the lowest compressive load. As such, in conventional embodiments, about 70% of the total shaft sealing force is applied by the first two packing elements, and as a consequence an uneven distribution of load versus pressure is generated across the packing elements 212, thus causing premature wear and localized frictional heat generation in the impacted packing elements.

### SUMMARY OF THE INVENTION

The present invention relates to a mechanical packing sealing assembly that is configured to apply a relatively even load to either end of the packing assembly so as to equalize the compressive forces applied to the packing assembly from both the compression gland and from the process fluid. This results in a more uniform axial to radial stress ratio under load versus pressure conditions, and results in minimal time required to effectively consolidate the packing assembly. This eliminates the need for periodic manual adjustment of the forces applied to the packing assembly by the gland, as required in conventional packing arrangements.

The present invention is directed to a mechanical packing sealing assembly suitable for use with a fluid regulating device having a gland element and a stationary equipment having a recess formed along an inner surface. The gland element can be coupled to the stationary equipment by a plurality of fasteners. The assembly can include an axially movable pressure adjustment element, a packing pressure adjustment element, and a position locking element. The axially movable pressure adjustment element has a main body having a radially outwardly extending first flange element formed at a first end and a radially inwardly extending second flange element formed at an opposed second end and forming a piston area. The first flange element has a plurality of fastener-receiving openings formed therein that are sized and configured for seating the plurality of fastener and the main body is sized and configured for seating within the recess formed in the stationary equipment. The packing pressure adjustment element can be sized and configured for seating over one or more of the plurality of fasteners and configured to be positioned, when mounted over the fastener, between the first flange element and the stationary equipment. The packing pressure adjustment element is axially movable along the fastener so as to selectively move the pressure adjustment element in the axial direction. The position locking element can be sized and configured for seating over one or more of the plurality of fasteners and configured to be positioned, when mounted over the fastener, between the first flange element and the gland element. The position pocking element is axially movable along the fastener and defines an axially outboard most position of the pressure adjustment element. The mechanical packing sealing assembly can also include a plurality of packing elements forming a packing assembly that are sized and configured for seating within the recess of the stationary equipment and about the pressure adjustment element.

The main body of the pressure adjustment element has an inner surface and an opposed outer surface. The outer surface has a groove formed therein at the second end of the main body that is sized and configured for seating a sealing element. The groove formed in the second end is formed in an outer surface of the second flange element. The second flange element is configured to selectively apply an axial force to the packing assembly when coupled to the main body. The pressure adjustment element is movable axially as a function of a pressure of a process fluid in the stationary equipment applied to the piston area. The gland element is configured to apply an axial pressure to the packing assembly in a first direction during use, and the second flange element is configured to selectively apply an axial force to the packing assembly in a second direction opposite to the first direction. The piston area of the second flange element is sized and configured for converting 100% or more of the pressure of the process fluid into the axial force applied to the packing assembly.

The present invention is also directed to a method for regulating an axial pressure applied to a packing assembly in a fluid regulating device. The fluid regulating device can include a gland element and a stationary equipment having a recess formed along an inner surface. The method can include providing a pressure adjustment element suitable for mounting in the recess of the stationary equipment and sized for mounting a packing assembly, providing a packing pressure adjustment element for moving the pressure adjustment element toward the gland element, providing a position locking element for defining an outboard most position of the pressure adjustment element, configuring the pressure adjustment element to be movable axially in response to a pressure of a process fluid in the stationary equipment applied to a piston area of the pressure adjustment element independent of the gland element, and configuring the piston area of the pressure adjustment element to apply an axial force to the packing assembly mounted in the stationary equipment and coupled to the pressure adjustment element during use based on the pressure of the process fluid.

The gland element, during use, can apply an axial force in a first direction to the packing assembly, and the pressure adjustment element can apply an axial force to the packing assembly during use in a second direction opposite to the first direction. The pressure adjustment element can include a radially inwardly extending flange element formed at an axially inboard end thereof. The flange element can form the piston area and the piston area can be configured to apply the pressure of the process fluid to the packing assembly during use. Further, the piston area can optionally apply 100% or more of the pressure of the process fluid to the packing assembly.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic depiction of a fluid regulating device employing a mechanical packing sealing assembly according to the teachings of the present invention.

FIG. 1 is a partial cross-section view of a fluid regulating device employing a mechanical packing sealing assembly according to the teachings of the present invention.

FIG. 2 is a partial cross-section view of a pressure adjustment element of the mechanical packing sealing assembly of FIG. 1 according to the teachings of the present invention.

FIG. 3 is a perspective view of the pressure adjustment element of the mechanical packing sealing assembly according to the teachings of the present invention.

FIG. 4 is a partial cross-section view of the fluid regulating device showing the various forces applies to the mechanical packing sealing assembly, during use, according to the teachings of the present invention.

FIG. 5 is a line graph showing the bi-directional forces applied to packing elements of a packing assembly mounted with the mechanical packing sealing assembly, during use, according to the teachings of the present invention.

FIG. 6 is a partial cross-sectional view of another embodiment of the pressure adjustment element according to the teachings of the present invention.

FIG. 7 is a partial cross-sectional view of the fluid regulating device showing various positions of selected components of the mechanical packing sealing assembly according to the teachings of the present invention.

FIG. 8 is partial cross-sectional view of the fluid regulating device showing different positions of selected components of the mechanical packing sealing assembly and the forces applied to the packing assembly, during use, according to the teachings of the present invention.

FIG. 9 is a partial cross-sectional view of a conventional fluid regulating device employing a gland element to apply axial pressure to the packing assembly.

FIG. 10 is a partial cross-sectional view of the conventional fluid regulating device of FIG. 9 showing the axial forces applied to the packing assembly, during use.

FIG. 11 is a line graph showing the conventional pressure profiles of the pressures applied to the packing assembly by the gland element and the process fluid pressure.

### DETAILED DESCRIPTION

The present invention is directed to a mechanical packing sealing assembly suitable for use with a fluid regulating device for reducing or minimizing leakage therefrom. The mechanical packing sealing system provides sealing forces in both axial directions and is self-regulating.

As used herein, the term “fluid regulating device” is intended to encompass any selected device that helps, assists, prevents, pumps, or regulates the flow of a fluid through a fluid transport or conveyance medium, such as a pipe or device. The fluid regulating device is preferably of a type that employs a packing material, and can include valves, regulators, pumps, and the like. When a valve is employed, the valves can have any selected size and shape, and can include for example a hydraulic valve, a manual valve, a pneumatic valve, a solenoid valve, a motor valve, a block valve, and the like. Those of ordinary skill in the art will readily recognize that the packing material of the present invention can also be used with mechanical seals in connection with pumps.

The term “shaft” is intended to refer to any suitable device in a mechanical system to which a mechanical seal can be mounted and includes shafts, rods, and other known devices. The shafts can move in any selected direction, such as for example in a rotary direction or in a reciprocating direction.

The terms “axial” and “axially” as used herein refer to a direction generally parallel to the axis of a shaft. The terms “radial” and “radially” as used herein refer to a direction generally perpendicular or transverse to the axis of a shaft. The terms “fluid” and “fluids” refer to liquids, gases, and/or combinations thereof.

The terms “axially inner” or “axially inboard” as used herein refer to the portion of the stationary equipment proximate the stationary equipment and the process fluid. With regard to equipment that mounts packing elements, the direction refers to the packing elements located proximate the process fluid. Conversely, the terms “axially outer” or “axially outboard” as used herein refer to the portion of stationary equipment distal from the process fluid and proximate an ambient environment.

The term “radially inner” as used herein refers to the portion of the system proximate a shaft. Conversely, the term “radially outer” as used herein refers to the portion of the system distal from the shaft.

The term “gland” or “gland element” as used herein is intended to include any suitable structure that enables, facilitates, or assists securing a mechanical seal to stationary equipment, while concomitantly surrounding or housing, at least partially, one or more seal components. The gland element can also be configured to move axially to apply a compressive force to a packing assembly. If desired, the gland element can also provide fluid access to the mechanical seal. Those of ordinary skill will also recognize that the gland assembly can form part of the mechanical seal assembly or form part of the stationary equipment.

The terms “stationary equipment,” “equipment,” and/or “static surface” as used herein are intended to include any suitable stationary structure or housing that surrounds or houses a shaft or rod and includes a stuffing box within which a packing assembly is mounted or to which a gland element is secured. The stationary structure can include any type of commercial or industrial equipment such as pumps, valves, and the like. Those of ordinary skill in the relevant art will readily recognize that the gland assembly can form part of the mechanical seal, packing loading assembly or part of the stationary equipment.

The terms “process medium” and/or “process fluid” as used herein generally refers to a medium or fluid housed within or being transferred through the stationary equipment. In pump applications, for example, the process medium is the fluid being pumped through the pump housing.

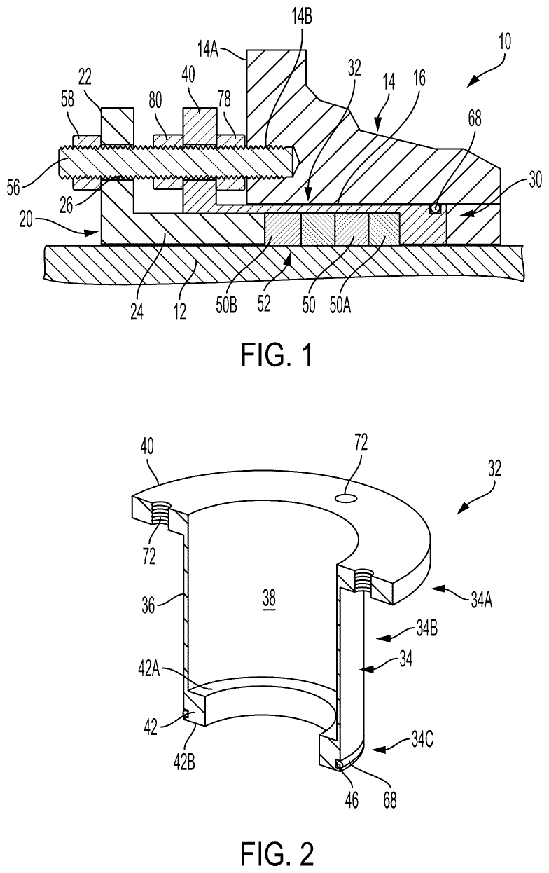

FIG. 1 illustrates a fluid regulating device that includes a mechanical packing sealing assembly according to the teachings of the present invention. The illustrated fluid regulating device 10 includes stationary equipment 14 that seats about a movable shaft 12, such as a rotating shaft. The fluid regulating device 10 also includes a compression gland or gland element 20. The stationary equipment 14 can include a groove 16 that is formed along an inner surface of the main body of the equipment to form a stuffing box. The groove 16 is sized and configured for seating a mechanical packing sealing assembly 30. The mechanical packing scaling assembly 30 is configured to seat and mount a series of packing elements 50. The packing elements 50, when mounted together in the mechanical packing sealing system 30, form a packing assembly 52.

The illustrated gland element 20 has a main body that has a top radially outwardly extending flange element 22 and an attached axially extending stem portion 24 that is oriented and positioned so as to contact a portion of the axially outboard most packing element 50B (e.g., axial outboard packing element) of the packing assembly 52. The gland element 20 can apply a compressive force to the packing assembly 52 by compressing the packing elements 50 in at least the axial direction so as to ensure sufficient sealing contact between the packing assembly 52 and the shaft 12. The compressive forces applied by the gland element 20 to the packing assembly 52 can be manually adjusted by way of an adjustment mechanism. Specifically, the fluid regulating device 10 can include a series of fasteners 56 that connect and fasten the gland element 20 to the stationary equipment 14. The fluid regulating device 10 can also include a gland adjustment nut 58 that functions as the adjustment mechanism for adjusting or varying the compressive forces applied by the gland element 20 to the packing assembly 52. Specifically, the gland adjustment nut 58 can be adjusted by the user based on the amount of compressive scaling force that needs to be applied to the packing assembly 52 to form a sufficient seal. For example, if the compressive forces need to be increased, the gland adjustment nut 58 can be adjusted by turning such that the stem portion 24 of the gland element moves axially inward to apply an enhanced or increased compressive force to the packing assembly 52. The gland element 20 applies a compressive force in a single axial inboard direction. In the illustrated embodiment, the stem portion 24 of the gland element 20 contacts the axial outboard packing element 50B.

The packing assembly 52 can include a series of individually stacked, axially abutting packing elements 50 that are generally ring shaped and formed of a selected type of packing material. The packing material typically comes in rope form that is cut to size by the user. The packing material is then shaped as a ring. The packing assembly 52 is formed by initially stacking together separate packing components 50. The seams of each of the packing elements 50 are oriented relative to each other and in a selected manner so as to reduce or minimize fluid leakage therethrough. The packing elements 50 are wrapped around the shaft 12 and provide an interface and dynamic sealing surface between the shaft 12 and the packing assembly 52. Over time, the packing assembly 52 tends to wear and lose volume, thus allowing emissions and process fluid to escape the fluid regulating device. In order to address the unwanted loss of volume and hence the increase in fluid loss and fugitive emissions, the operator or user can typically compress the packing assembly 52 further via the gland element 20 by adjusting the gland adjustment nut 58.

The packing elements 50 of the packing assembly 52 of the present invention can have any selected shape and size, and can be formed in an interbraid pattern or a square braid pattern, or any other suitable braiding pattern known to those of ordinary skill in the art. The packing element 50 can be in the form of a braided material that is commonly square or round when viewed in cross section, although the packing element 50 can be provided in a variety of different cross-sectional shapes. Multiple packing elements 50 can be provided in the recess or groove 16 of the stationary equipment 14 along the length of the shaft 12 to form the packing assembly 52 in order to provide a seal around the shaft 12. Although the present invention can be employed with any suitable type and shape of packing material, for the sake of simplicity, a square braid pattern can be employed and is shown. The square braid can be formed by braiding together multiple individual yarns, typically of the same type of material, along a set of material paths. Further, the packing element 50 can be formed of a packing material that includes one or more yarn components that are disposed within a reinforcing material or structure, such as a wire mesh, to form a packing strand. The illustrated packing element 50 has a main body that has a plurality of side surfaces if a square braid. The main body can be optionally coated with any suitable material, such as polytetrafluoroethylene (PTFE), as is known in art. The yarn can be formed of any suitable material and can be formed for example of graphite. Other materials include mica, vermiculite, and polytetrafluoroethylene (PTFE). The wire mesh can be formed of any suitable material, such as metal, examples of which include copper, brass, lead, Inconel, stainless steel, or Monel materials. The illustrated packing element 50 is formed by braiding together individual packing strands or yarns to form the packing element. One of ordinary skill in the art will readily recognize that the packing material can be formed from multiple different types of materials and can be braided in a symmetrical or asymmetrical manner relative to a lateral or horizontal axis across a cross-sectional face of the packing material. The packing material forming the packing element can be selected for specific applications and to exhibit selected properties. Examples of various types of braids and braiding patterns are shown in U.S. Pat. No. 9,388,903, the contents of which are herein incorporated by reference. Examples of the type of packing elements suitable for use in the packing cartridge of the present invention include the 1400R, 1600, 1601, and 1622 brand packing materials sold by A.W. Chesterton Co., the assignee hereof. Other types of packing materials can also be used. The packing assembly 52 can also include any selected number of packing elements 50, and preferably includes between three and seven packing elements 50. The packing assembly 52 can also optionally include one or more spacer elements in lieu of one or more packing elements 50.

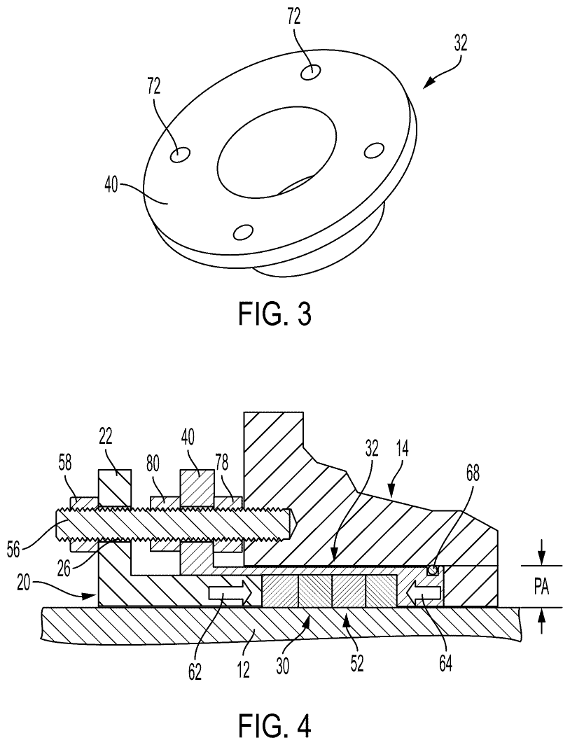

With reference to FIGS. 1-4, the illustrated mechanical packing sealing system 30 includes a pressure adjustment element 32 that is sized and configured to seat within the groove or channel 16 formed in the inner surface of the stationary equipment 14. The pressure adjustment element 32 is configured to seat within the groove 16 and to seat about the outer surfaces of the packing elements 50 forming the packing assembly 52. The pressure adjustment element 32 is configured to exert an axial compressive force on the axial inboard side of the packing assembly 52 in a direction opposite to the force applied by the gland element 20, as shown by arrow 64 (FIG. 4). The pressure adjustment element 32 can help control the compressive forces applied to the packing assembly 52 based on variations in the pressure of the process fluid. The pressure adjustment element 32 can have, if desired, a pressure balance diameter that forms a selected compressive pressure load on the packing assembly 52 and helps adjust the radial stress distribution along the packing assembly 52, while concomitantly controlling the lubrication needed for proper operation of the fluid regulating device. This eliminates the need for periodic manual adjustments of the gland element 20 by the operator.

The illustrated pressure adjustment element 32 can include a main body 34 having an outer surface 36 and an opposed inner surface 38. The main body has a top portion 34A, an opposed bottom portion 34C, and an intermediate portion 34B coupling together and extending between the top and bottom portions. The top portion 34A of the main body 34 has a flange element 40 formed thereon that extends radially outward from the outer surface 36. According to one embodiment, the flange element 40 forms the top portion of the pressure adjustment element 32. The flange element 40 is configured to optionally interact with a top surface of the stationary equipment 14 when the pressure adjustment element 32 is seated within the groove 16. The intermediate portion 34C of the main body 34 has an axial length that is sufficient to space the flange element 40 from a top surface 14A of the stationary equipment 14. The inner surface 38 of the main body can have an optional groove (not shown) formed therein at the top portion 34A of the main body that is sized and configured for seating a sealing element, such as an O-ring. The scaling element can optionally contact an outer surface of the stem portion 24 of the gland element 20, so as to help reduce or prevent leakage of process fluid from the stationary equipment. The inner surface 38 of the main body 34 has a radially inwardly extending flange element 42 that is located at the bottom portion 34B of the main body 34. The bottom flange element 42 has a top surface 42A that is configured to contact the axial inboard packing element 50A and has an opposed bottom surface 42B. The overall radial width of the bottom flange element 42 forms a piston area PA (FIG. 4) that the process fluid within the stationary equipment 14 can act upon by applying a force thereto. The radial width of the bottom flange element 42 can be selectively sized so a to convert the process fluid pressure into an axial compressive force. The outer surface 36 of the main body 34 can also have an optional channel or groove 46 formed along a bottom portion of the main body that is sized and configured for seating a sealing element, such as an O-ring 68. The sealing element 68 contacts an inner surface or wall of the recess 16, so as to help prevent leakage of the process fluid from the stationary equipment 14.

The illustrated top flange element 40 of the pressure adjustment element 32 can include a series of spaced apart fastener receiving apertures 72 for receiving, for example, one or more of the fasteners 56. The apertures 72 can be threaded or unthreaded (forming through holes) as a function of the types of fasteners 56 being employed. According to one embodiment, as shown in FIG. 2, at least two opposed apertures 72 can be threaded and are sized and configured for receiving the threaded fasteners 56. The other or remaining pair of opposed holes can be threaded or unthreaded. FIG. 6 shows an alternate embodiment of the pressure adjustment element 32 showing the apertures 72 configured as through holes. The threaded apertures work with the nuts for pulling the pressure adjustment element 32 towards the gland element 20. The clearance or through holes help guide the movement of the gland element 20. The apertures 72 of the flange element 22 can be aligned with fastener-receiving apertures 14B formed in the top surface 14A of the stationary equipment 14. The fasteners 56 can be positioned so as to seat within both of the apertures 72 formed in the flange element 40 and the apertures 14B formed in the stationary equipment 14.

The mechanical packing sealing assembly 30 can also include a position locking element 80, such as a position locking nut 80, that helps determine the axially outermost or outboard position of the pressure adjustment element 32 within the groove 16. The position locking nut 80 seats over the fastener 56 and is axially disposed between the flange 24 of the gland element 20 and the flange 40 of the pressure adjustment element 32. The position locking nut 80 can be set by a user to fix or secure the axial outermost position of the pressure adjustment element 32. The mechanical packing sealing assembly 30 can also include a second position adjustment element 78, such as a packing pressure adjustment nut 78, for adjusting the axial innermost position of the pressure adjustment element 32 and hence adjusting the axial pressure applied to the packing assembly 52 by the pressure adjustment element 32. The packing pressure adjustment nut 78 can be positioned along the shaft of fastener 56 at a selected axial position so as to selectively apply and adjust a compression force to the packing assembly 52 with the bottom flange element 42. The position locking nut 80 can be positioned so as to lock or fix the axial position of the pressure adjustment element 32.

In operation, the pressure adjustment element 32 is mounted within the groove or recess 16 formed in the inner surface of the stationary equipment 14. The pressure adjustment element 32 is positioned such that the fastener receiving apertures 72 are aligned with the apertures 14B formed in the top surface 14A of the stationary equipment 14, such that the fasteners 56 seat within the apertures 72, 14B. Similarly, the packing pressure adjustment nut 78, if employed, is positioned over the fastener 56 and is positioned between the flange element 40 of the pressure adjustment element 32 and the top surface 14A of the stationary equipment 14. Similarly, the position locking nut 80, if employed, is positioned over the fasteners 56 and above a top surface of the flange element 40. The packing elements 50 are then mounted and stacked along the inner surface 38 of the main body 34 of the pressure adjustment element 32 to form the packing assembly 52. The axially innermost or axial inboard packing element 50A contacts the top surface 42A of the bottom flange element 42. The bottom surface 42B of the flange element 42 is disposed adjacent to (or in contact with) a radially extending wall or surface of the recess 16. Alternatively, a spacer element can be optionally employed and can be mounted in place of one or more of the axial inboard packing elements. The remaining packing elements 50 are stacked along the inner surface 38, with the packing element 50B forming the axially outboard or axially outermost packing element. The gland element 20 is then positioned such that the apertures 26 formed in the flange element 22 are positioned over the fasteners 56, and the fastener 56 is then seated within the apertures 26. The gland adjustment nut 58 is then disposed over the fasteners 56. The axially outboard packing element 50B contacts a terminal end portion or region of the stem portion 24 of the gland element 20. The pressure adjustment element 32 can be movable axially as a function of the pressure of the process fluid when the process fluid applies a force on the piston area PA of the bottom flange element 42. The gland element 20 can also be secured to the stationary equipment 14 by the fasteners 56, and the gland adjustment nut 58 can be adjusted to a selected position so as to apply a selected compressive force to the packing assembly 52 via the stem portion 24 of the gland element 20. Specifically, the stem portion 24 comes into mating contact with the packing elements 50 and is disposed in mating contact with the axial outboard packing element 50B. The stem portion 24 applies a compressive force to the packing elements 50. The packing elements 50 and the pressure adjustment element 32 can optionally form part the mechanical packing sealing system 30 of the present invention.

The gland adjustment nut 58 can be adjusted by the user to apply a selected compressive force to the packing assembly 52 via the gland element 20. Similarly, the axially innermost or inboard position of the pressure adjustment element 32 can be selected via the packing pressure adjustment nut 78 and the axially outermost or outboard position of the pressure adjustment element 32 can be secured or locked in place with the position locking nut 80. The packing pressure adjustment nut 78 and the position locking nut 80 can also optionally form part of the mechanical packing sealing assembly 30.

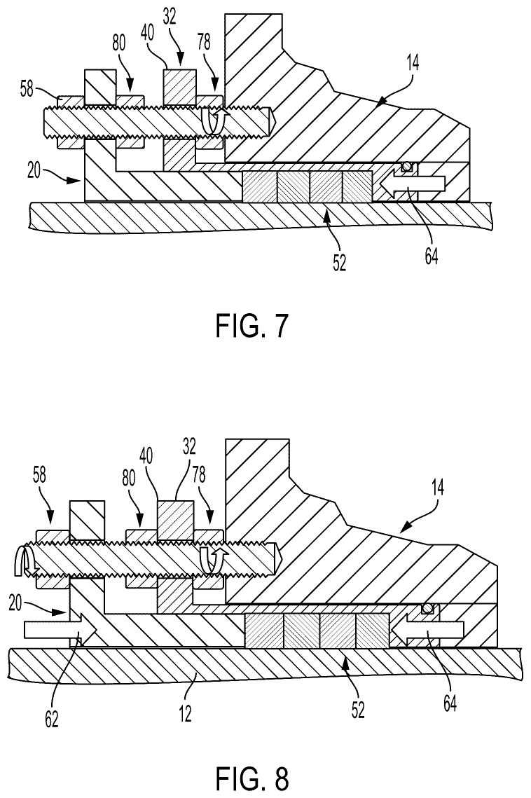

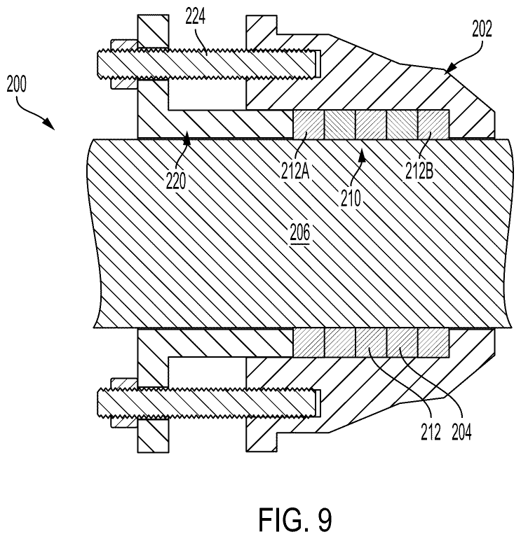

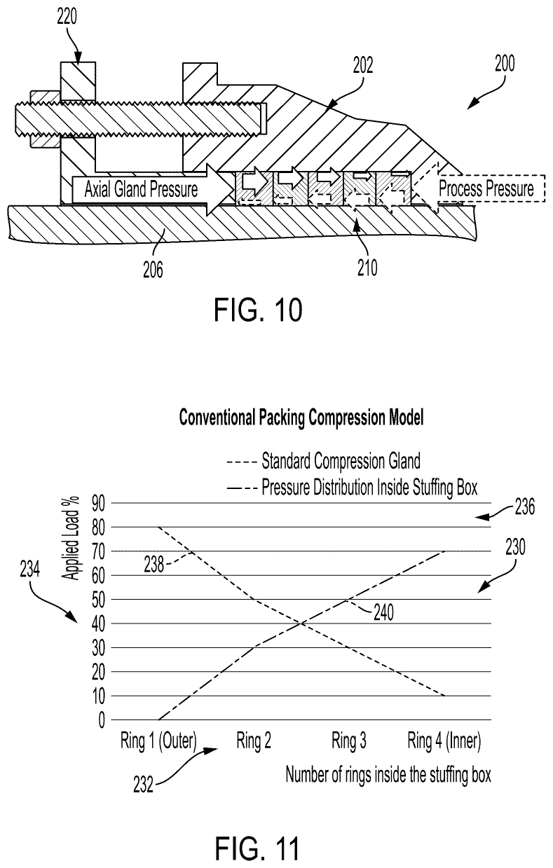

The adjustment elements or nuts 58, 78 and the position locking nut 80 can be adjusted such that the mechanical packing sealing assembly 30 can operate in one or more of three select operational modes. According to a first operational mode, as shown in FIG. 7, the pressure adjustment element 32 can be employed to provide a compressive axial load or force to the packing assembly 52 without specifically positioning the gland element 20 to apply a compressive load to the packing assembly 52. Specifically, the gland adjustment nut 58 can be axially separated from or positioned relative to the gland element 20 such that the gland element 20 does not apply, or minimally applies, a compressive force to the packing assembly 52. The position locking nut 80 can be axially separated from the flange element 40 of the pressure adjustment element 32 so as to not restrict the axial position thereof. The packing pressure adjustment nut 78 can be adjusted to a selected position such that the nut 78 forces the pressure adjustment element 32 to apply an axial compressive force to the packing assembly 52 in the outboard direction (arrow 64). In this first operational mode, the position locking nut 80 is separated from the flange element 40 and the packing pressure adjustment nut 78 is rotated by the user to push or force the pressure adjustment element 32 towards the gland element 20, such that the pressure adjustment element 32 pushes or forces the packing assembly against the stationary or fixed gland element 20. As shown, the position locking nut 80 is disposed in a possible final axially outboard most position. The compressive forces applied by the pressure adjustment element 32 as a function of the packing elements 50 are similar to line 240 of graph 230 in FIG. 11.

According to a second operational mode, the gland element 20 can be employed to provide a compressive load to the packing assembly 52 without specifically positioning the pressure adjustment element 32 to apply a compressive load to the packing assembly 52. Specifically, the packing pressure adjustment nut 78 and the position locking nut 80 can be axially separated from the flange element 40 of the pressure adjustment element 32 (not shown), such that the pressure adjustment element 32 is essentially axially free floating therebetween. In the second operational mode, the compressive forces are localized on the axial outboard packing element 50B and on one or more adjacent packing elements 50. As such, the compressive forces as a function of packing elements are similar to line 238 of graph 230 in FIG. 11.

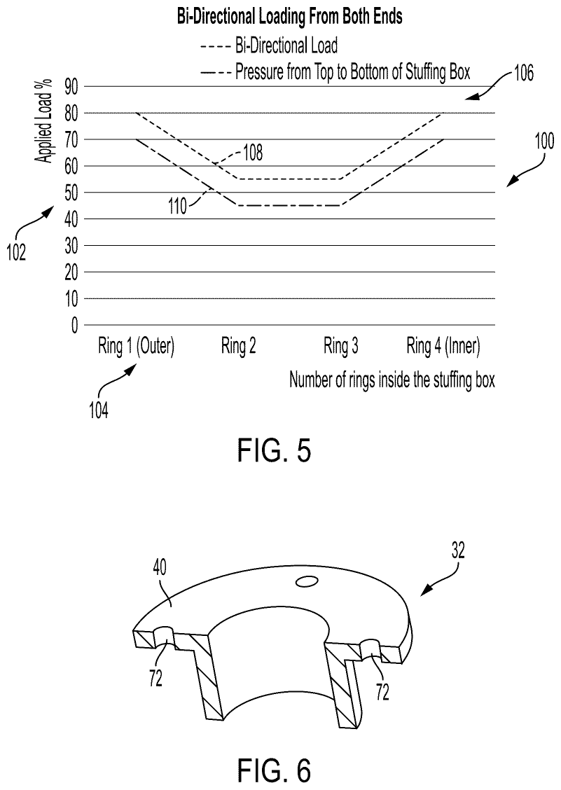

According to a third operational mode, as shown for example in FIG. 8, the pressure adjustment element 32 and the gland element 20 can simultaneously or synchronously be employed to provide a compressive load to the packing assembly 52 in the axial inboard and in the axial outboard directions. Specifically, the gland adjustment nut 58 can be positioned to force the gland element 20 to apply an axial compressive force to the packing assembly 52 (arrow 62), and the position locking nut 80 and packing pressure adjustment nut 78 can also be employed to position the pressure adjustment element 32 to apply an axial force to the packing assembly 52 (arrow 64). The position locking nut 80 in this operational mode is disposed adjacent to the flange element 40 of the pressure adjustment element 32. The compressive forces can thus be applied in both the axial inboard direction as shown by arrow 62 and in the axial outboard direction as shown by arrow 64. In this operational mode, the compressive forces apply a synchronous axial load on the packing assembly 52 simultaneously. FIG. 5 is a line graph 100 showing the percentage of applied load positioned along the Y-axis 102 relative to the specific packing elements 50, denoted as packing rings, positioned along the X-axis 104. The illustrated graph 100 shows the axial distribution of compressive forces across the packing assembly 52 as a function of the compression forces applied by the gland element 20 and the pressure adjustment element 32. The line graph 100 includes a legend 106 indicating information associated with the lines 108, 110 of the line graph 100. As shown, the line 108 indicates the force information associated with the compressive forces applied to the packing elements 50 from both directions by the gland element 20 and by the pressure adjustment element 32. As illustrated, the forces applied to the packing elements 50 are significantly more uniform than in conventional packing systems (see FIG. 11). Specifically, the forces applied to the intermediate packing elements are subjected to compressive forces that are similar to the forces applied to the axially outboard most packing element 50B and to the axially inboard most packing element 50A. The packing rings 2 and 3 (e.g., packing elements 50) are subjected to between about 40-50% of the total compressive forces applied to the packing assembly 52.

Those of ordinary skill in the art will readily recognize that the process fluid can also act upon the bottom flange element 42 of the pressure adjustment element 32, as in the first operational mode. Specifically, the process fluid can apply a compressive force to the piston area PA defined by the flange element 42. For example, as the process fluid pressure increases, the pressure applied by the process fluid pressure to the piston area PA of the bottom flange element 42 also increases, thus axially moving the pressure adjustment element 32 in an axial outboard direction (arrow 64). When this occurs, the packing elements 50 are compressed between the gland element 20 and the bottom flange element 42 of the pressure adjustment element 32. Further, the bottom flange element 42 can be configured to form the piston area PA of a selected size, so as to provide a force area that when exposed to the process fluid pressure provides a balanced load on the packing assembly 52. For example, the bottom flange element 42 can be sized so as to apply just a portion of or all of the overall process fluid pressure to the packing assembly 52. Further, the piston area PA formed by the bottom flange element 42 can be preselected or adjusted by selecting the inside diameter of the flange element. By adjusting the piston area formed by the bottom flange element, the amount of force applied by the process fluid to the pressure adjustment element 32 can be preselected. In mechanical packing scaling systems, a small amount of process fluid leakage is expected and required for lubrication and cooling of the packing assembly, so as to reduce friction between the packing elements and the rotating shaft. According to one embodiment, the pressure adjustment element of the mechanical packing sealing assembly can include a bottom flange element having a piston area that translates between about 70% and about 80%, and optionally as much as 100%, and further optionally higher than 100%, such as for example between about 100% and about 120% (e.g., 110%), of the process fluid pressure into an axial compressive force. As such, the flange element can be configured to translate a selected percentage of the process fluid pressure within this pressure range to an axial compressive force. Further, the piston area PA acting on the packing assembly 52 can reach generally the shaft diameter, as the area of the packing assembly 52 between the shaft 12 and an inside diameter of the bottom flange element 42 is also exposed to process fluid pressure. The percentage of the process fluid pressure that can be converted into an axial pressure by the piston area can be determined by dividing the piston area by the area of the stuffing box. By way of simple example, suppose that the shaft has a diameter of 2 inches, the diameter defined by the groove (e.g., stuffing box) has a diameter of 3.125 inches, and the bottom flange element 42 has an inner diameter of 2.25 inches. The balance percentage or the amount of process fluid pressure used for loading the packing assembly 52 is equivalent to the area of the piston area divided by the area of the cross-section of the stationary equipment:

$$π / 4 ( 3.125 - 2 ) / π / 4 ( 3. - 2. ) = 1.125 = 112 \% .$$

Therefore, the system 10 is balanced so that the process pressure (e.g., 112%) acts upon the bottom flange element 42 to provide a force or load on the packing assembly.

The self-regulating nature of the mechanical packing sealing system 30 reduces (or eliminates) the need to manually adjust the compression on the packing assembly 52 with the gland element 20, since the pressure adjustment element 32 moves axially based on the pressure or forces applied by the process fluid and/or by the position of the packing pressure adjustment nut 78. According to operational mode, the axial movement of the pressure adjustment element can be independent of the gland element. According to other operational modes, the axial movement of the pressure adjustment element 32 can be dictated by the packing pressure adjustment nut 78 and/or by the position locking nut 80. The balanced nature of the load on the packing assembly 52 better distributes the forces across all of the packing elements 50 in the packing assembly 52 in an axial and radial manner, rather than just localizing the compressive forces selected ones of the packing elements 50A, 50B, thus reducing the overall wear of the packing elements. Further, the mechanical packing sealing system 30 can be employed in different stuffing box styles (e.g., straight bore or bottomed bore).

According to another embodiment of the present invention, the pressure adjustment element 32 can a series of fastener-receiving apertures or holes, that can include at least a pair of threaded holes for enabling one or more of the packing pressure adjustment nut 78 and the position locking nut 80 to pull or control axial movement of the pressure adjustment element 32 into or against the gland element 20, and a pair of unthreaded apertures (e.g., through or clearance holes) that can help guide the movement of the gland element 20.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

We claim:

1. A mechanical packing sealing assembly suitable for use with a fluid regulating device having a gland element and a stationary equipment having a recess formed along an inner surface, wherein the gland element is coupled to the stationary equipment by a plurality of fasteners, comprising
an axially movable pressure adjustment element having a main body that has a radially outwardly extending first flange element formed at a first end and a radially inwardly extending second flange element formed at an opposed second end and forming a piston area, wherein the first flange element has a plurality of fastener-receiving openings formed therein that are sized and configured for seating the plurality of fastener, and wherein the main body is sized and configured for seating within the recess formed in the stationary equipment,
a packing pressure adjustment element sized and configured for seating over one or more of the plurality of fasteners and configured to be positioned, when mounted over the fastener, between the first flange element and the stationary equipment, wherein the packing pressure adjustment element is axially movable along the fastener so as to selectively move the pressure adjustment element in the axial direction, and
a position locking element sized and configured for seating over one or more of the plurality of fasteners and configured to be positioned, when mounted over the fastener, between the first flange element and the gland element, and wherein the position pocking element is axially movable along the fastener and defines an axially outboard most position of the pressure adjustment element.

2. The mechanical packing sealing assembly of claim 1, further comprising a plurality of packing elements forming a packing assembly that are sized and configured for seating within the recess of the stationary equipment and about the pressure adjustment element.

3. The mechanical packing sealing assembly of claim 1, wherein the main body of the pressure adjustment element has an inner surface and an opposed outer surface, wherein the outer surface has a groove formed therein at the second end of the main body that is sized and configured for seating a sealing element.

4. The mechanical packing sealing assembly of claim 3, wherein the groove formed in the second end is formed in an outer surface of the second flange element.

5. The mechanical packing sealing assembly of claim 4, wherein the second flange element is configured to selectively apply an axial force to a packing assembly when coupled to the main body, and wherein the pressure adjustment element is movable axially as a function of a pressure of a process fluid in the stationary equipment applied to the piston area.

6. The mechanical packing sealing assembly of claim 5, wherein the gland element is configured to apply an axial pressure to the packing assembly in a first direction during use, and wherein the second flange element is configured to selectively apply an axial force to the packing assembly in a second direction opposite to the first direction.

7. The mechanical packing sealing assembly of claim 6, wherein the piston area of the second flange element is sized and configured for converting 100% or more of the pressure of the process fluid into the axial force applied to the packing assembly.

8. A method for regulating an axial pressure applied to a packing assembly in a fluid regulating device, wherein the fluid regulating device includes a gland element and a stationary equipment having a recess formed along an inner surface, comprising
providing a pressure adjustment element suitable for mounting in the recess of the stationary equipment and sized for mounting a packing assembly,
providing a packing pressure adjustment element for moving the pressure adjustment element toward the gland element,
providing a position locking element for defining an outboard most position of the pressure adjustment element,
configuring the pressure adjustment element to be movable axially in response to a pressure of a process fluid in the stationary equipment applied to a piston area of the pressure adjustment element independent of the gland element, and
configuring the piston area of the pressure adjustment element to apply an axial force to the packing assembly mounted in the stationary equipment and coupled to the pressure adjustment element during use based on the pressure of the process fluid.

9. The method of claim 8, wherein the gland element during use applies an axial force in a first direction to the packing assembly, further comprising applying an axial force to the packing assembly with the pressure adjustment element during use in a second direction opposite to the first direction.

10. The method of claim 8, wherein the pressure adjustment element includes a radially inwardly extending flange element formed at an axially inboard end thereof, wherein the flange element forms the piston area, further comprising configuring the piston area to apply the pressure of the process fluid to the packing assembly during use.

11. The method of claim 8, further comprising configuring the piston area to apply 100% or more of the pressure of the process fluid to the packing assembly.

12. The method of claim 8, further comprising converting with the piston area the process fluid pressure into an axial force.
